(19) United States
(12) Patent Application Publication
(10) Pub. No.: US 2013/0011263 A1
(43) Pub. Date: Jan. 10, 2013

(54) SYSTEM AND METHOD FOR LUBRICANT FLOW CONTROL

(76) Inventors: Pradip Radhakrishnan SUBRAMANIAM, Bangalore (IN); Gangumalla Venkat RAO, Bangalore (IN)

(21) Appl. No.: 13/176,028

(22) Filed: Jul. 5, 2011

(51) Int. Cl. F03D 11/00; F16H 57/04

(52) U.S. Cl. 416/174; 184/6.12

(57) ABSTRACT

A wind turbine includes at least one turbine blade coupled to a rotor and configured to rotate about a central axis, a gearbox having an input configured to receive rotational input from the rotor, and an output configured to direct rotational output to a generator, a flow passageway configured to receive a lubrication fluid and direct the lubrication fluid to at least one component within the gearbox and a primary variable orifice device positioned along the flow passageway and configured to selectively vary an area of an orifice within the passageway in dependence upon at least one of a temperature or a viscosity of the lubrication fluid.

### FIELD OF THE INVENTION

Embodiments of the invention relate generally to wind turbines and, more particularly, to a system and method for lubricant flow control for a wind turbine gearbox.

### BACKGROUND OF THE INVENTION

Wind turbines typically include a rotor having multiple blades. The blades are attached to a rotatable hub, and the blades and hub, together, are customarily referred to as the rotor. The rotor transforms mechanical wind energy into a mechanical rotational torque that drives one or more generators. The generators are usually, but not always, rotationally coupled to the rotor through a gearbox. The gearbox steps up the inherently low rotational speed of the turbine rotor for the generator to efficiently convert the rotational mechanical energy to electrical energy, which is fed into a utility grid. The rotor, generator, gearbox and other components are typically mounted within a housing, or nacelle, that is positioned on top of a base that may be a truss or tubular tower.

As will be readily appreciated, losses generated by the wind turbine produce heat within the gearbox which must be dissipated. Often, a lubrication fluid, such as oil, is used to dissipate the heat within the gearbox. In addition, the gearbox may need to be lubricated to function effectively. Thus, in addition to cooling the gearbox, oil or another lubrication fluid is typically used for lubrication in a gearbox. In particular, in a typical wind turbine gearbox, external piping and internal features formed in structural components of the gearbox distribute oil or other lubrication fluid from a manifold to gear meshes and bearings, as well as other components of a gearbox. Various gear meshes and bearings of the gearbox require lubrication fluid in different amounts at different ambient and fluid temperatures.

Since the ambient temperature range in which wind turbines operate is very wide, lubrication fluid viscosity can vary significantly. In particular, when lubrication fluid such as oil is warm, it flows readily and is non-viscous, but when oil is cold it becomes viscous and resists flow. This variation in oil viscosity with ambient temperature can result in erratic flow distributions. For example, some flow channels and some components may receive a much higher rate, and therefore greater volume, of oil flow than is necessary, while other flow channels and components may be starved of oil flow. In one method for lubricating a gearbox at all operating conditions (e.g., at all potential ambient temperatures), the geometry of the lube flow channels is optimized and more oil is added to the system. This method, however, may result in some components, including gear meshes and bearings, being flooded with oil, which adversely impacts operating efficiency, increases oil consumption, and results in increased weight and costs.

### BRIEF DESCRIPTION OF THE INVENTION

An embodiment of the present invention relates to a wind turbine. The wind turbine includes at least one turbine blade coupled to a rotor and configured to rotate about a central axis, a gearbox having an input configured to receive rotational input from the rotor, and an output configured to direct rotational output to a generator, a flow passageway configured to receive a lubrication fluid and direct the lubrication fluid to at least one component within the gearbox and a variable orifice device positioned along the flow passageway and configured to selectively vary an area of an orifice within the passageway in dependence upon at least one of a temperature or a viscosity of the lubrication fluid.

According to another embodiment of the present invention, a system for lubricant flow control for a wind turbine gearbox includes at least one turbine blade coupled to a rotor and configured to rotate about a central axis, a gearbox having an input configured to receive rotational input from the rotor, and an output configured to direct rotational output to a generator, a flow passageway configured to receive a lubrication fluid and direct the lubrication fluid to at least one component within the gearbox, a primary variable orifice device positioned along the flow passageway and a flow control unit in communication with the primary variable orifice device, the flow control unit configured to control operation of the primary variable orifice device, for selectively varying an area of an orifice within the flow passageway, in dependence upon at least one of a temperature or a viscosity of the lubrication fluid.

Another embodiment of the present invention relates to a method for lubricant flow control for a wind turbine gearbox. The method includes the steps of providing a lubrication fluid source, circulating a lubrication fluid from the lubrication fluid source through a flow passageway and into the gearbox, and selectively varying a flow of the lubrication fluid through the flow passageway and into the gearbox in dependence upon at least one of a temperature or viscosity of the lubrication fluid.

According to another embodiment of the present invention, a system for lubricant flow control for a wind turbine or gearbox includes a flow control unit configured to be operatively coupled with a variable orifice device and with a sensor. The flow control unit is configured to receive information from the sensor of at least one of a temperature or a viscosity of a lubrication fluid and to generate signals for controlling operation of the variable orifice device, to selectively vary an extent to which the lubrication fluid can flow through a flow passageway, based on the information.

### BRIEF DESCRIPTION OF THE DRAWINGS

The present invention will be better understood from reading the following description of non-limiting embodiments, with reference to the attached drawings, wherein below:

FIG. 1 is a schematic side elevation view of an exemplary power-generating wind turbine.

FIG. 2 is a schematic view of a nacelle that may be used with the wind turbine shown in FIG. 1.

FIG. 3 is a schematic diagram of a lubrication system for a wind turbine gearbox according to an embodiment of the present invention.

FIG. 4 is a cross-sectional view of a variable orifice device for use in the lubrication system of FIG. 3 according to an embodiment of the present invention.

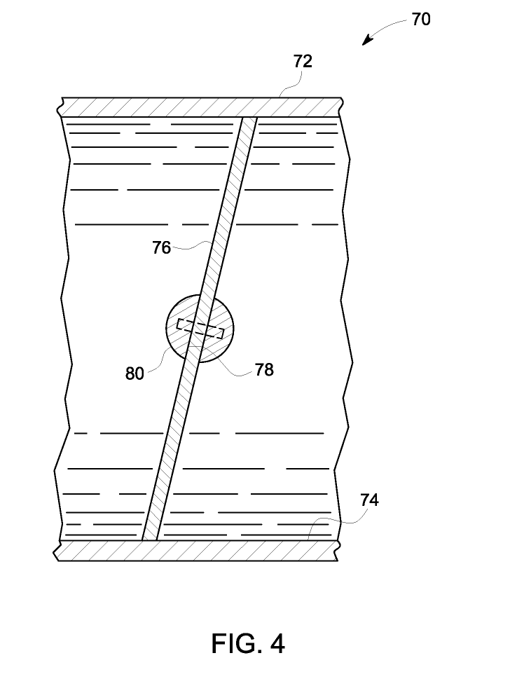

### DETAILED DESCRIPTION OF THE INVENTION

Reference will be made below in detail to exemplary embodiments of the invention, examples of which are illustrated in the accompanying drawings. Wherever possible, the same reference numerals used throughout the drawings refer to the same or like parts. Although exemplary embodiments of the present invention are described with respect to wind turbine gearboxes, embodiments of the invention are also applicable for use with gearboxes or wind turbines generally.

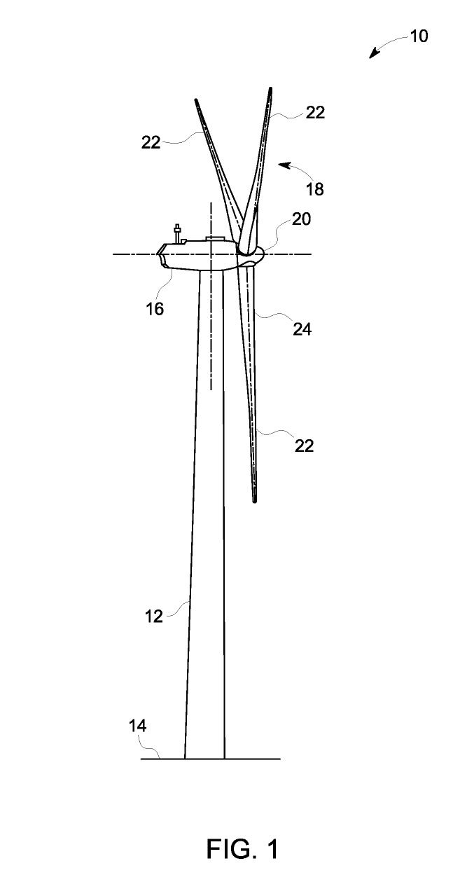

FIG. 1 is a schematic illustration of an exemplary wind turbine 10. As shown therein, the wind turbine 10 has a tower 12 extending from a supporting surface 14, a nacelle 16 mounted on the tower 12, and a rotor 18 coupled to the nacelle 16. The rotor 18 has a rotatable hub 20 and a plurality of rotor blades 22 coupled to hub 20. In an embodiment, rotor 108 has three rotor blades 112. In other embodiments, rotor 18 may have more or less than three rotor blades 22 without departing from the broader aspects of the present invention. In an embodiment, the tower 12 may be fabricated from tubular steel and has a cavity (not shown) extending between supporting surface 14 and nacelle 16. The height of tower 12 is selected based upon factors and conditions known in the art.

Blades 22 are positioned about rotor hub 20 to facilitate rotating rotor 18 to transfer kinetic energy from the wind into usable mechanical energy, and subsequently, into electrical energy. Blades 22 are mated to hub 20 by coupling a blade root portion 24 to hub 20.

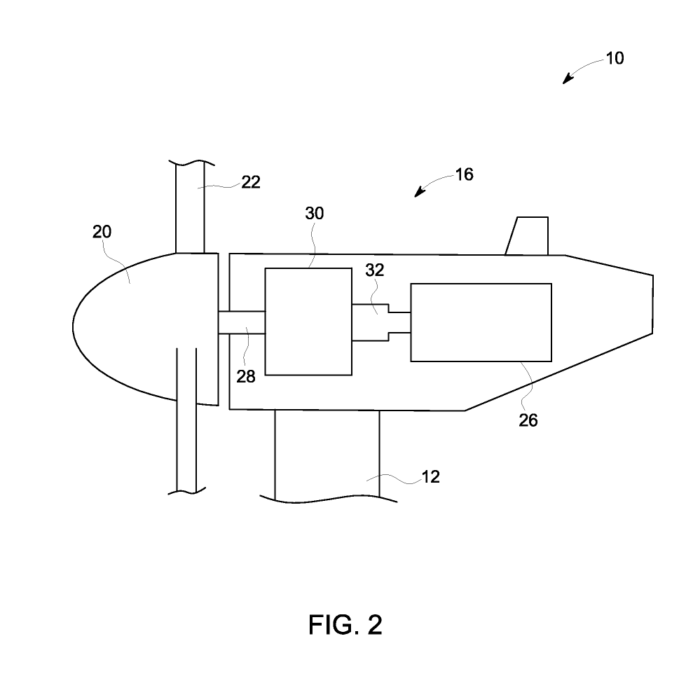

FIG. 2 is a schematic view of nacelle 16 of the wind turbine 10. As shown therein, various components of the wind turbine 10 are housed in nacelle 16 atop the tower 12 of wind turbine 10.

The rotor 18 is rotatably coupled to an electric generator 26 positioned within the nacelle 16 via a rotor shaft 28, sometimes referred to as low speed input shaft 28, a gearbox 30 and a high-speed output shaft 32. In particular, as shown therein, the gearbox 30 comprises the input shaft 28 being rotated by the blades 22 by wind power, various meshed gears (not shown) operatively connected to the input shaft 28 for converting the low speed rotation of the input shaft 28 to a higher speed rotation of the output shaft 32, and the output shaft 32. The output shaft 32 is connected to the generator 26 by a coupling (not shown). The output shaft 32 rotatably drives the generator and facilitates generator 26 production of electric power.

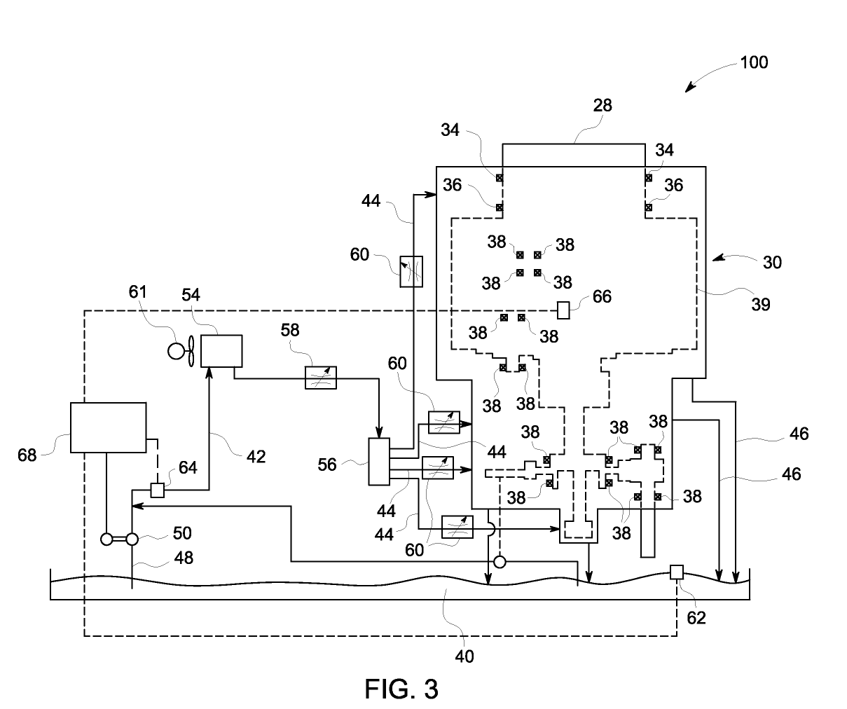

As best shown in FIG. 3, forward and aft support bearings 34 and 36, respectively, are positioned within the gearbox 30 and facilitate radial support and alignment of the shaft 28. The gearbox 30 also includes a plurality of additional bearings 38 that support various gears (such as multi-stage gear set 39 for converting the low speed rotation of the input shaft 28 to a higher speed rotation of the output shaft 32), shafts (such as output shaft 32) and other components required for the operation thereof. Gearboxes, and in particular the various bearings 34, 36, 38 and gear meshes contained therein, typically require lubrication fluid to function effectively. This lubrication fluid may be an oil. Accordingly, embodiments of the invention relate to a lubrication system for a gearbox.

FIG. 3 shows an embodiment of the lubrication system 100. As shown therein, the lubrication system includes an oil sump 40 and a flow passageway. The flow passageway includes a main oil circulating line 42, a plurality of oil distribution lines 44 and at least one oil return line 46. The main oil circulating line 42 supplies oil from the oil sump 40 to the gearbox 30. In the main oil circulating line 42, a suction tube 48, a pump 50, an oil cooler 54, and a manifold 56 for oil distribution are arranged.

The pump 50 may be configured to increase the pressure of the oil in the lubrication system 100, and direct pressurized oil downstream into the lubrication manifold. In an embodiment, the pump 50 is an electrical pump. It will be readily appreciated, however, that other suitable pumps may be utilized without departing from the broader aspects of the present invention. In an embodiment, the sump 40 and the return line 46 are external to the gearbox 30. However, it will be readily appreciated that in other embodiments the sump 40 and/or the return line 46 may be internal components in the gearbox 30, preventing the line from being damaged or ruptured during installation or repair.

In an embodiment, a primary variable orifice device 58 is positioned along the main circulating line 42 upstream from the manifold 56. As used herein, “orifice” is intended to mean an opening, aperture or passageway, such as in a tube, conduit or pipe. As also used herein, “variable orifice device” is intended to mean a device that is capable of varying (e.g., being controlled to vary) a cross-sectional area of an orifice within the device so as to increase or decrease the flow of lubricant oil therethrough. In embodiments where the passageway or orifice is circular in cross-section, the cross-sectional area of the orifice/passageway may be varied by varying the effective diameter of the orifice or passageway. While an embodiment of the present invention utilizes passageways that are circular in cross-section, passageways and orifices of any configuration may also be employed without departing from the broader aspects of the present invention.

In general operation, the oil pump 50 is actuated and lubrication oil is drawn from the oil sump 40, through the suction tube 48 extending therein and into the main oil circulating line 42. The oil is then directed through the main oil circulating line 42 to the oil cooler 54, to the primary variable orifice device 58, and ultimately to the oil manifold 58, in succession. From the oil manifold 58, the lubrication oil is carried by the various oil distribution lines 44 to the various bearings 34, 36, 38 and gear meshes (not shown) within the gearbox 30 that require lubrication for effective operation. As shown in FIG. 3, in an embodiment, each of the oil distribution lines 44 includes a secondary variable orifice device 60 for adjusting the flow of oil within each line prior to the oil being distributed to the specific components within the gearbox 30, as discussed in detail below. Return lines 46 then direct the excess/used oil from the gearbox 30 back to the oil sump 40, for reuse.

As will be readily appreciated, the interior of a working gearbox 30 is at an elevated temperature due to the numerous moving parts therein. As such, the heat generated by the moving and intermeshing of gears and bearings is transferred, at least partially, to the lubrication fluid injected into the gearbox. This heated oil is then distributed back to the sump. Prior to reuse, however, it may be desirable to cool the oil back to ambient or other operating temperature. Accordingly, oil cooler 54 having a fan 61 can be employed along the main oil circulating line 42 to cool the lubrication fluid to a predetermined temperature prior to distribution to the specific components of the gearbox 30.

As alluded to above, the various bearings and gear meshes contained within the gearbox 30 require lubrication oil in different amounts at different ambient/oil temperatures. Generally, as temperature of the oil decreases, and viscosity increases, less oil is required to lubricate the bearings and gear meshes. Accordingly, the system 100 of the present invention further includes various temperature sensors placed at various locations within the lubrication system 100. In one embodiment, the system includes a sump temperature sensor 62 positioned within the oil sump 40 for monitoring a temperature thereof, a main line temperature sensor 64 for monitoring a temperature of oil passing through the main circulating line 42, and gearbox temperature sensor 66 positioned within the gearbox 30 for monitoring a temperature therewithin. Each of the temperature sensors 62, 64, 66 are electrically connected to a flow control unit 68. In operation, as oil is circulated through the system 100, the temperature sensors 62, 64, 66 continuously monitor the temperature of oil at various points within the system and relay the detected temperatures to the flow control unit 68 in real time.

The flow control unit 68 is configured to adjust the flow volume of lubrication oil through the main circulating line 42 and distribution lines 44 in dependence upon the detected temperatures, and thus the viscosity, of the oil. In particular, the flow control unit 68 is in “electrical communication” with the primary variable orifice device 58 in the main circulating line 42 and the secondary variable orifice devices 60 in the distribution lines 44. As used herein, “electrical communication” means that certain components are configured to communicate with one another through direct or indirect signaling by way of direct or indirect electrical connections. As the temperature of the lubrication oil decreases, and the viscosity increases, the flow control unit 68 sends a signal to the primary variable orifice device 58 in the main circulating line 42 and/or the secondary variable orifice devices 60 in the distribution lines 44 to reduce the area of the orifice therein to restrict oil flow to the manifold 56 and through the distribution lines 44, respectively (in the case of a circular passageway or orifice, this is effectuated by decreasing the diameter of the orifice). As a result, the bearings and gear meshes within the gearbox 30 receive a lighter, and more optimum, flow of oil at lower temperatures.

In an embodiment, viscosity measuring devices may be utilized in place of, or in addition to, one or more of the temperature sensors 62, 64, 66 to measure the viscosity of the lubrication fluid/oil instead of, or in addition to, the temperature thereof As with the embodiment described above, the viscosity measuring devices may be electrically connected to the flow control unit 68 such that the viscosity measuring devices continuously monitor the viscosity of the oil/lubrication fluid at various points within the system and relay the detected viscosity readings to the flow control unit 68 in real time. The flow control unit 68 may then send a signal to one or more of the variable orifice devices 58,60 to restrict or increase lubrication fluid flow, as necessary.

Moreover, in an embodiment, the flow control unit may include a database containing all the to-be-lubricated components within the gearbox 30 and the amount of oil required for optimum operation at various temperatures. When the flow control unit 68 receives input data in the form of oil temperature, the flow control unit can automatically determine the optimum oil flow for each component and then instruct the primary and secondary variable orifice devices 58, 60 to adjust the orifice diameter to meet the required flow levels for each component. As will be readily appreciated, by specifically tailoring oil flow to the requirements of the internal components of the gearbox 30 at specific temperatures, oil consumption, and therefore cost and size of the system 100 and pump 50, is decreased.

Conversely, if ambient/oil temperature increases, the bearings and gear meshes will require more lubricating oil for smooth operation. In this instance, the temperature sensors 62, 64, 66 detects the increase in oil temperature, which is relayed to the flow control unit 68, and the flow control unit 68 sends a signal to the primary and secondary variable orifice devices 58, 60 to increase the of the orifice therein to increase oil flow to the manifold 56 and through the distribution lines 44, respectively area (in the case of a circular passageway or orifice, this is effectuated by increasing the diameter of the orifice). As a result, the bearings and gear meshes within the gearbox 30 receive a heavier, and more optimum, flow of oil at higher temperatures. In this manner, the diameter of the variable orifice is adjusted in dependence upon the temperature, and thus viscosity, of the lubrication oil to provide for optimum oil flow at all ambient/oil temperatures.

In this manner, the level of variability of lubrication oil flow through the system 100 can be controlled on a main flow level and/or on subsystem/specific component level. In particular, the primary variable orifice device 58 in the main circulating line 42 can be selectively controlled by the flow control unit 68 to provide an optimum level of oil flow to the manifold 56, and thus to the gearbox 30, on a main flow level. In this mode, the area of the orifice in the primary variable orifice device 58 in the main circulating line 42 is adjusted in dependence upon the temperatures detected by temperature sensors 62, 64, 66 to obtain an optimum level of flow to the manifold 56, while the secondary variable orifice devices 60 in the distribution lines 44 are not adjusted. As will be readily appreciated, this is the most basic level of flow control which allows oil flow to be adjusted in the main circulating line 42 such that the flow through each distribution line 44, and thus to each component of the gearbox 30, is the same.

Alternatively, in an embodiment, the secondary variable orifice device in each oil distribution line 44 can each be selectively controlled individually by the flow control unit 68 to provide an optimum level of oil flow to each specific component of the gearbox 30, on a subsystem level. In this mode, the area of the orifice in each secondary variable orifice device in each distribution line 44 is adjusted in dependence upon the temperatures detected by temperature sensors 62, 64, 66 to obtain an optimum level of flow to each specific component of the gearbox 30. As will be readily appreciated, this allows for a much more tailored flow of oil to each bearing, gear mesh, etc. than can be provided by varying the level of flow in the main circulating line 42, alone.

In view of the above, an embodiment of the system 100 of the present invention allows for the level of flow to be varied on a main level alone, a subsystem level alone, or both a main and subsystem level by selectively varying one or more of the primary and secondary variable orifice devices 58,60, respectively.

In an embodiment, the variable orifice devices 58,60 may be throttle-type valves. A cross-sectional view of an exemplary throttle valve 70 is shown in FIG. 3. As shown therein, the throttle valve 70 is in fluid communication with the main circulating line 42 and/or distribution lines 60 and includes a body structure 72 having formed therethrough a passageway 74 for the passage of lubrication fluid, which has disposed therein a rotatable valve member or butterfly plate 76. The valve member 76 may be received in a slot 78 formed in a shaft 80 supported by the body 72. In operation, the throttle valve 70, directly regulates the amount of lubrication fluid passing through ht main circulating line 42 and/or distribution lines by adjusting the position of the valve member 76.

In other embodiments, the variable orifice devices 58, 60 may be flow control valve-type valves. In particular, in an embodiment the variable orifice devices 58,60 may be throttle control valves having adjustable output flow. In other embodiments, the variable orifice devices 58,60 may be flow control valves, e.g., a variable output control valve, metered flow control valve, or metered flow control valve with relief port. In an embodiment, the variable orifice devices 58, 60 may be pressure/temperature compensated metered flow control valves.

In an embodiment, the variable orifice device 58 may also include a pilot operated or solenoid controlled flow control valve in which a piston-cylinder arrangement may be employed as a means of obtaining variable flow, as desired. In particular, the variable orifice can be implemented by utilizing a piston-cylinder arrangement whereby the piston movement within the cylinder varies the orifice area to regulate the flow of oil through the main circulating line 42 and/or the distribution line(s) 44.

As will be readily appreciated, the system 100 of the present invention reduces gear and bearing failures by providing sufficient oil flow to the gears and bearings at all operating conditions. Moreover, the system 100 increases efficiency due to churning losses in oil-flooded components by providing for more optimal flow regulation. As a result, overall reliability of the gearbox 30 is improved. In addition, system pressure is decreases as compared to known methods, as less oil is introduced into the system to meet component requirements at all operating conditions. As will be readily appreciated, this improves overall system reliability.

While the embodiments disclosed herein discuss the use of oil as a lubricating media, each of the embodiments may be more broadly applicable to lubrication fluid generally. Indeed, it is not intended that oil is the only lubrication fluid that may be used in connection with the embodiments described herein, but that any lubrication fluid known in the art may be used with the system and method for lubricant flow control of the present invention.

An embodiment of the present invention relates to a wind turbine. The wind turbine may include at least one turbine blade coupled to a rotor and configured to rotate about a central axis, a gearbox having an input configured to receive rotational input from the rotor, and an output configured to direct rotational output to a generator, a flow passageway configured to receive a lubrication fluid and direct the lubrication fluid to at least one component within the gearbox and a primary variable orifice device positioned along the flow passageway and configured to selectively vary an area of an orifice within the passageway in dependence upon at least one of a temperature or a viscosity of the lubrication fluid. The flow passageway may include a main circulating line and a plurality of distribution lines, wherein the primary variable orifice device is positioned along the main circulating line. A secondary variable orifice device may be positioned along each of the distribution lines, wherein each of the secondary variable orifice devices may selectively vary an area of an orifice of the distribution lines in dependence upon the temperature or the viscosity of the lubrication fluid. The wind turbine may further include at least one temperature sensor for monitoring a temperature of the lubrication fluid. In addition, the wind turbine may include a flow control unit in electrical communication with the temperature sensor and the primary variable orifice device which controls the variable orifice devices in dependence upon the temperature detected by the temperature sensor. The flow control unit may also be in electrical communication with each secondary variable orifice device to control each secondary variable orifice device in dependence upon the temperature detected and at least one operating parameter of the at least one component of the gearbox. The variable orifice devices may be a throttle control valve or a solenoid-controlled flow control valve. Each of the second variable orifice devices may be a throttle control valve, a variable output control valve or a metered-flow control valve. The wind turbine may also include a lubrication fluid sump and a pump for circulating the lubrication fluid through the flow passageway.

According to another embodiment of the present invention, a system for lubricant flow control for a wind turbine gearbox includes at least one turbine blade coupled to a rotor and configured to rotate about a central axis, a gearbox having an input configured to receive rotational input from the rotor, and an output configured to direct rotational output to a generator, a flow passageway configured to receive a lubrication fluid and direct the lubrication fluid to at least one component within the gearbox, a primary variable orifice device positioned along the flow passageway and a flow control unit in communication with the primary variable orifice device, the flow control unit configured to configured to selectively vary an area of an orifice within the flow passageway, and a flow control unit configured to control operation of the primary variable orifice device, for selectively varying an area of an orifice within the flow passageway, in dependence upon at least one of a temperature or a viscosity of the lubrication fluid. The system may further include at least one temperature sensor in electrical communication with the flow control unit for monitoring a temperature of the lubrication fluid. The flow passageway can include a main circulating line and a plurality of distribution lines wherein the variable orifice device is positioned along the circulating line. A secondary variable orifice device may be positioned along each of the distribution lines to selectively vary an area of an orifice within each of the distribution lines in dependence upon the temperature or the viscosity of the lubrication fluid. The flow control unit may be in communication with each secondary variable orifice device such that it controls operation of each secondary variable orifice device in dependence upon the temperature of the viscosity of the lubrication fluid. Each secondary variable orifice device may be a throttle control valve.

Another embodiment of the present invention relates to a method for lubricant flow control for a wind turbine gearbox. The method includes the steps of providing a lubrication fluid source, circulating a lubrication fluid from the lubrication fluid source through a flow passageway and into the gearbox, and selectively varying a flow of the lubrication fluid through the flow passageway and into the gearbox in dependence upon a viscosity of the lubrication fluid. The method may further include the steps of monitoring a temperature of the lubrication fluid source and relaying the temperature to a flow control unit. The step of varying a flow of the lubrication fluid may include selectively varying an area of the flow passageway. The method may further include the step of cooling the lubrication fluid prior to circulating the lubrication fluid into the gearbox.

Another embodiment relates to a method of lubricant flow control for a wind turbine gearbox. The method comprises circulating a lubrication fluid from a lubrication fluid source through a flow passageway and into the gearbox. The method further comprises controlling (e.g., with a control unit) a flow of the lubrication fluid through the flow passageway and into the gearbox in dependence upon at least one of a temperature or a viscosity of the lubrication fluid. The step of controlling may comprise generating control signals for a valve or other variable orifice device associated with the flow passageway. The method may further comprise a step of receiving information of the temperature and/or the viscosity from at least one sensor.

Another embodiment relates to a system for lubricant flow control for a wind turbine. The system comprises a flow control unit configured to be operatively coupled with (e.g., electrically coupled with) a variable orifice device and with a sensor. The flow control unit is configured to receive information from the sensor of a temperature and/or a viscosity of a lubrication fluid (i.e., of at least one of the temperature or the viscosity). The flow control unit is configured to generate signals for controlling operation of the variable orifice device, to selectively vary an extent to which the lubrication fluid can flow through a flow passageway (e.g., the variable orifice device is in or otherwise associated with the passageway), based on the information. The flow control unit may be a standalone electronic unit having an input for connection with the sensor and an output for connection with the variable orifice device, or it may be a general purpose control unit for a wind turbine that is additionally configured as indicated, or it may be a software module comprising instructions (e.g., non-transitory tangible medium having the instructions stored thereon) that when executed by a processor- or controller-based device cause the processor- or controller-based device to interact with the sensor and variable orifice device as indicated, the sensor and variable orifice device being electrically connected to the processor- or controller-based device.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of ordinary skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” “third,” “upper,” “lower,” “bottom,” “top,” etc. are used merely as labels, and are not intended to impose numerical or positional requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the invention, including the best mode, and also to enable one of ordinary skill in the art to practice the embodiments of invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the above-described system and method for lubricant flow control, without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. A wind turbine, comprising:
at least one turbine blade coupled to a rotor and configured to rotate about a central axis;
a gearbox having an input configured to receive rotational input from the rotor, and an output configured to direct rotational output to a generator;
a flow passageway configured to receive a lubrication fluid and direct the lubrication fluid to at least one component within the gearbox; and
a primary variable orifice device positioned along the flow passageway and configured to selectively vary an area of an orifice within the passageway in dependence upon at least one of a temperature or a viscosity of the lubrication fluid.

2. The wind turbine of claim 1, wherein:
the primary variable orifice device is a throttle control valve.

3. The wind turbine of claim 1, wherein:
the variable orifice is a solenoid-controlled flow control valve.

4. The wind turbine of claim 1, further comprising:
a lubrication fluid sump; and
a pump for circulating the lubrication fluid through the flow passageway.

5. The wind turbine of claim 1, wherein:
the flow passageway includes a main circulating line and a plurality of distribution lines, the primary variable orifice device being positioned along the main circulating line.

6. The wind turbine of claim 5, further comprising:
for each of the plurality of distribution lines, a respective secondary variable orifice device positioned along the distribution line, the secondary variable orifice device configured to selectively vary an area of an orifice within the distribution line in dependence upon said at least one of the temperature or the viscosity of the lubrication fluid.

7. The wind turbine of claim 6, wherein:
each secondary variable orifice device is a throttle control valve.

8. The wind turbine of claim 6, wherein:
each secondary variable orifice device is a variable output control valve.

9. The wind turbine of claim 6, wherein:
each secondary variable orifice device is a metered flow control valve.

10. The wind turbine of claim 6, further comprising:
at least one temperature sensor for monitoring the temperature of the lubrication fluid; and
a flow control unit in electrical communication with the at least one temperature sensor and each secondary variable orifice device, the flow control unit controlling each secondary variable orifice device in dependence upon a temperature detected by the at least one temperature sensor and at least one operating parameter of the at least one component.

11. The wind turbine of claim 10, wherein:
the flow control unit is in electrical communication with the primary variable orifice device, the flow control unit further being configured to control the primary variable orifice device in dependence upon the temperature of the lubrication fluid as detected by the at least one temperature sensor.

12. A system for lubricant flow control for a wind turbine gearbox, comprising:
at least one turbine blade coupled to a rotor and configured to rotate about a central axis;
a gearbox having an input configured to receive rotational input from the rotor, and an output configured to direct rotational output to a generator;
a flow passageway configured to receive a lubrication fluid and direct the lubrication fluid to at least one component within the gearbox;
a primary variable orifice device positioned along the flow passageway; and
a flow control unit in communication with the primary variable orifice device, the flow control unit configured to control operation of the primary variable orifice device, for selectively varying an area of an orifice within the flow passageway, in dependence upon at least one of a temperature or a viscosity of the lubrication fluid.

13. The system of claim 12, further comprising:
at least one temperature sensor for monitoring the temperature of the lubrication fluid, the at least one temperature sensor being in electrical communication with the flow control unit.

14. The system of claim 12, wherein:
the flow passageway includes a main circulating line and a plurality of distribution lines, the primary variable orifice device being positioned along the main circulating line.

15. The system of claim 14, further comprising:
for each of the plurality of distribution lines, a respective secondary variable orifice device positioned along the distribution line; and
wherein the flow control unit is in communication with each secondary variable orifice device and is configured to control operation of each secondary variable orifice device in dependence upon said at least one of the temperature or the viscosity of the lubrication fluid, to selectively vary an area of an orifice within the distribution line associated with the secondary variable orifice device.

16. The system of claim 15, wherein:
each secondary variable orifice device is a throttle control valve.

17. A method of lubricant flow control for a wind turbine gearbox, the method comprising the steps of:
circulating a lubrication fluid from a lubrication fluid source through a flow passageway and into the gearbox; and
selectively varying a flow of the lubrication fluid through the flow passageway and into the gearbox in dependence upon at least one of a temperature or a viscosity of the lubrication fluid.

18. The method of claim 17, further comprising the steps of:
monitoring a temperature of the lubrication fluid source; and
relaying the temperature to a flow control unit for control of a device to vary the flow of the lubrication fluid through the flow passageway.

19. The method of claim 17, wherein the step of varying a flow of the lubrication fluid comprises:
selectively varying an area of the flow passageway.

20. The method of claim 17, further comprising the steps of:
cooling the lubrication fluid prior to circulating the lubrication fluid into the gearbox.

21. A system for lubricant flow control for a wind turbine or gearbox, comprising:
a flow control unit configured to be operatively coupled with a variable orifice device and with a sensor;
wherein the flow control unit is configured to receive information from the sensor of at least one of a temperature or a viscosity of a lubrication fluid;
and wherein the flow control unit is configured to generate signals for controlling operation of the variable orifice device, to selectively vary an extent to which the lubrication fluid can flow through a flow passageway, based on the information.
